(19) United States
(12) Patent Application Publication
(10) Pub. No.: US 2023/0237114 A1
(43) Pub. Date: Jul. 27, 2023

(54) SYSTEMS AND METHODS FOR FACILITATING QUERY SEMINALITY IN WEB BROWSING

(71) Applicant: SKYROCKET TECH INC., South Jordan, UT (US)

(72) Inventor: Jason Bosarge, South Jordan, UT (US)

(21) Appl. No.: 18/101,255

(22) Filed: Jan. 25, 2023

Related U.S. Application Data
(60) Provisional application No. 63/407,277, filed on Sep. 16, 2022.
(60) Provisional application No. 63/302,855, filed on Jan. 25, 2022.
(60) Provisional application No. 63/302,809, filed on Jan. 25, 2022.

(51) Int. Cl. G06F 16/954; G06F 16/9535; G06F 16/951; G06F 16/9538; G06F 3/04817; G06F 3/0483

(52) U.S. Cl. CPC G06F 16/954; G06F 16/9535; G06F 16/951; G06F 16/9538; G06F 3/04817; G06F 3/0483

(57) ABSTRACT

Systems, methods, and devices include browsers for facilitating and preserving query seminality in web browsing. Navigation between different tabbed content is facilitated by corresponding query containers that group tabbed search result content and that monitor and maintain the browsing state of the different search results.

### CROSS-REFERENCE TO RELATED APPLICATIONS

This application claims the benefit of and priority to U.S. Provisional Patent Application Ser. No. 63/407,277 filed on Sep. 16, 2022 and entitled “SYSTEMS AND METHODS FOR FACILITATING QUERY SEMINALITY IN WEB BROWSING,” U.S. Provisional Patent Application Ser. No. 63/302,855 filed on Jan. 25, 2022 and entitled “ZERO INDEX SERACH AND NAVIGATION INTERFACES AND SYSTEMS,” and U.S. Provisional Patent Application Ser. No. 63/302,809 filed on Jan. 25, 2022 and entitled “ZERO INDEX SERACH AND NAVIGATION INTERFACES AND SYSTEMS,” wherein all of the foregoing are incorporated herein by reference in their entireties.

### BACKGROUND

Various systems and interfaces have been created for accessing and navigating content on the Internet. For instance, when a user enters search terms into a browser interface, that browser will generate a search request that is sent to one or more search engines to identify indexed content corresponding with the search terms. When the browser receives search results back from the search engine(s), the browser will display the search results with controls for accessing and navigating through the search results.

It is typical for search engines to utilize tabs to facilitate access to different search results that correspond to a single query or to different queries. For instance, a user can select a control for generating a new tab (e.g., the “+” icon within the tab view bar of the browser) to launch a new tab from which the user can perform a new search to navigate new content. Likewise, a user can use menu controls to trigger the generation of a new tab corresponding to a selected term or link from within one webpage to spawn an additional tabbed webpage. The different tabs within the browser window are selectable to enable a user to quickly navigate to the content of a corresponding tab is selected. The use of such tabs are well-known to those of skill in the art.

One problem with existing schemes for navigating browser tabs, however, is that it can be difficult to manage and organize all of the tabs that a user may open during a browsing session. In particular, it can be difficult to track or remember which tabs correspond to the different search terms and queries used to spawn the different tabs.

Sometimes, it can also be hard to initiate new search queries without worrying about losing current tabbed results or without worrying about over populating the tabbed view bar. For instance, a user may have to launch a new tab just to perform a new query, otherwise the current content displayed in a current webpage will be lost if a new search is performed from the existing page.

It can also be difficult to remember the context and relevance of a tab to a search that was previously performed, without having to navigate backwards to the search page from a particular tabbed search result.

It can also be difficult to sort or organize the different tabs, corresponding to different searches, without having to grab and manually move the tabs around along with the tab view bar.

Accordingly, in view of the foregoing and other problems associated with conventional Internet browsers, there is an ongoing need and desire for improved browsers that can facilitate access to and navigation of Internet search results.

### SUMMARY

Disclosed embodiments include systems and methods for utilizing browsers that are configured to facilitate navigation between different tabbed content and the management browsing state with the use of query containers and corresponding container controls.

For instance, in some embodiments, systems are configured with browsers that utilize query containers and corresponding container icons for navigating search results that are grouped within respective containers as tabbed search results. Each search query corresponds to a different query container/container icon and a different corresponding set of tabbed search results for that search query. These query containers can help facilitate the management of different browsing session states and the navigation to prior and existing search results, as described herein.

Initially, a browser window is rendered with a query field where the user can enter search terms (e.g., the search query). Then, a search is performed for content comprising search results corresponding to the user input, or search terms/queries, entered into the query field. Notably, the search results are rendered as webpages, with different webpages corresponding to different tabs, wherein the tabbed webpages are grouped into a respective query container that has its own container icon displayed within the browser window. The container icon and the corresponding tabbed search results of that container are displayed simultaneously at the browser window when the container is rendered in an active focus state (e.g., it has been inherently selected/activated in response to a search and/or it has been actively selected by a user selecting the container icon).

By way of example, in response to a first search query, a first container icon is displayed at the browser window corresponding to the first query. This container icon will be displayed in an active focus state (reflecting the content associated with the container is currently selected and/or being navigated) and prior to receiving any additional user input for selecting and activating a different container icon in the browser window. Concurrently with generating and displaying the container icon, the system also generates a first set of search result tabs corresponding to the first query, with each search result tab in the first set of search result tabs corresponding to a different search result resource (e.g., webpage) related to the first query. Notably, however, the system will only selectively cause the first set of search result tabs to be displayed within the browser window when the container icon is displayed in the active focus state. Once a different container is selected, the tabbed content of the first container are no longer displayed and are replaced in the browser window by the tabbed content of the different container that has been selected.

By way of example, in some embodiments, a system will receive user input selecting and redirecting focus to a different/second container icon in the browser window, subsequent to displaying the first container icon. This may occur, for instance, by performing a new query that causes the generation of the different container and container icon. Alternatively, this may occur when a user selects a container icon from a previous query. Either way, in response to the user input selecting and redirecting focus to the second container icon, the system will dynamically (i) refrain from displaying the first search result tabs corresponding to the first query, (ii) render the first container icon with an inactive focus state, (iii) generate a second set of search result tabs corresponding to the second container icon, each search result tab of the second set of search result tables corresponding to a different search result resource related to a second query, and (iv) render the second container icon in the active focus state.

In some instances, the disclosed systems will also generate and render an identifier on or proximate a container icon to reflect changes in state of one or more of the search result resources that correspond to a respective query container that is not actively selected or displayed in an active focus state, and even though this means that the underlying search result tabs of that container are not currently being displayed by the browser window. This identifier can be a symbol, a number, a character or highlighting used to render or to be rendered with the container icon.

In some instances, the disclosed systems update the searches performed for previous search queries for the different query containers, in the background, while the corresponding query containers are in an inactive focus state. When new results are discovered, the system will render the new content as tabbed search result pages that are displayed when the user selects the corresponding container icon associated with the updated query container. The systems may also update the container icon to reflect the updated status of the query container and the presence of new search result content, even before the user selects the container icon.

The disclosed browsers are also configured, in some instances, to render a predetermined quantity of container icons within the browser window, in a container bar/ribbon, to facilitate ease of navigation between the different containers and corresponding tabbed search results. Once the predetermined quantity of displayed container icons has been reached on the container view bar, any newly created container will cause a new container icon to be generated and rendered in the view bar of the browser window and to push at least one the existing container icons off of the container view bar out of view.

Disclosed systems are also configured to cache the search result content (e.g., tabbed search result pages) for the different containers to reduce latency when navigating back and forth between the content. However, in some instances, when a less relevant container is determined to fall below a relevance threshold (e.g., based on timing and/or based on the creation of a new container that causes the container icon of the less relevant container to be bumped off of the container view bar), the container state and tabbed search results/contents are removed from cache, and the container's icon or another container reference is moved to a container navigation log.

After the container icon is removed from the container view bar on the browser window, if a user wishes to reactivate the container and place the corresponding container icon back onto the container bar/ribbon of the browser window, the user can navigate through the browser menus to identify and select the corresponding container icon from the container navigation log. This selection will trigger (i) a new search for content associated with the initial container query, as well as (ii) the repositioning of the container icon back on the container view bar, and (ii) the rendering of tabbed search results that are displayed with the container icon, when the container is rendered in an active focus state (e.g., until focus/attention is redirected to a new or different container, as previously described).

The systems are also configured to track the browsing state and attention directed to different tabbed search results between the different containers, such that a user can be redirected to previously selected tabs of each container when the user navigates back and forth between the different containers, without losing their historical navigation points of reference within each container.

Yet other embodiments include the use of ballistic queries, which enable a user to simultaneously initiate multiple queries based on a single input string entered into the query field. In some instances, for example, a first query set of one or more terms is separated by a ballistic separator (e.g., a period) from a second query set of one or more terms within a single query submission.

The ballistic separator indicates to the system/browser that the search term(s) of the first query set corresponds to a first search and that the search term(s) of the second query set corresponds to a separate search to be performed. They may be performed at the same time, or sequentially (e.g., with the second search to be performed immediately after performing the first search, without further user input). In such embodiments, the systems generate different container icons with corresponding grouped search result tabs for each of the different searches.

Many of the foregoing embodiments and others described herein can be used to help facilitate the manner in which a user accesses and navigates content on the Internet.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of a conventional browser window.

FIGS. 2-12 illustrates non-limiting examples of browser windows configured to be used with a browser that utilizes query containers that group tabbed search result content and that monitor and maintain the browsing state of the different search results.

FIG. 13 illustrates a flow-diagram of acts associated with disclosed embodiments for utilizing query containers that group tabbed search result content and that monitor and maintain the browsing state of the different search results.

FIG. 14 illustrates a non-limiting example of a computing system that includes and/or that may be used to implement aspects of the disclosed invention.

FIG. 15-19 illustrate non-limiting examples of browser windows that utilize query containers that group tabbed search result content and that present search result tabs in a view bar next to a federated icon panel of selectable icons for accessing federated/filtered search results of the search result content.

### DETAILED DESCRIPTION

As noted above, disclosed embodiments include systems and methods for facilitating and preserving query seminality (e.g., importance, organization, and context) in web browsing. Navigation between different tabbed search result content is facilitated by corresponding query containers that group tabbed search result content and that monitor and maintain the browsing state of the different search results, as will be described in more detail below.

In some instances, the containers are immutable, such as the search query (e.g., terms) used to trigger the search associated with each container are maintained to preserve the context of each container. The search results (e.g., tabbed webpages) are also preserved in cache for containers that are determined to be relevant (e.g., a predetermined number of containers), wherein the container icons of the relevant containers are rendered in a container view bar.

When a container relevance is determined to fall below a certain threshold, based on age or relative attention to other containers that have been created subsequent to the less relevant container, then the corresponding container icon is removed from the container view bar and the container is referenced in a container navigation log for subsequent reference. At this point, the contents (other than the search query terms associated with the container) are removed from the browser cache. As previously noted, the tabbed content of a container are displayed only when that container is selected and rendered in an active focus state.

In view of the foregoing and subsequent disclosure, it will be appreciated that the disclosed invention provides many technical benefits, including the preservation of browsing status while refraining from caching irrelevant content, the automatic grouping and organization of search results based on search term context within corresponding containers, and the ability to navigate quickly between search results of existing and previous queries.

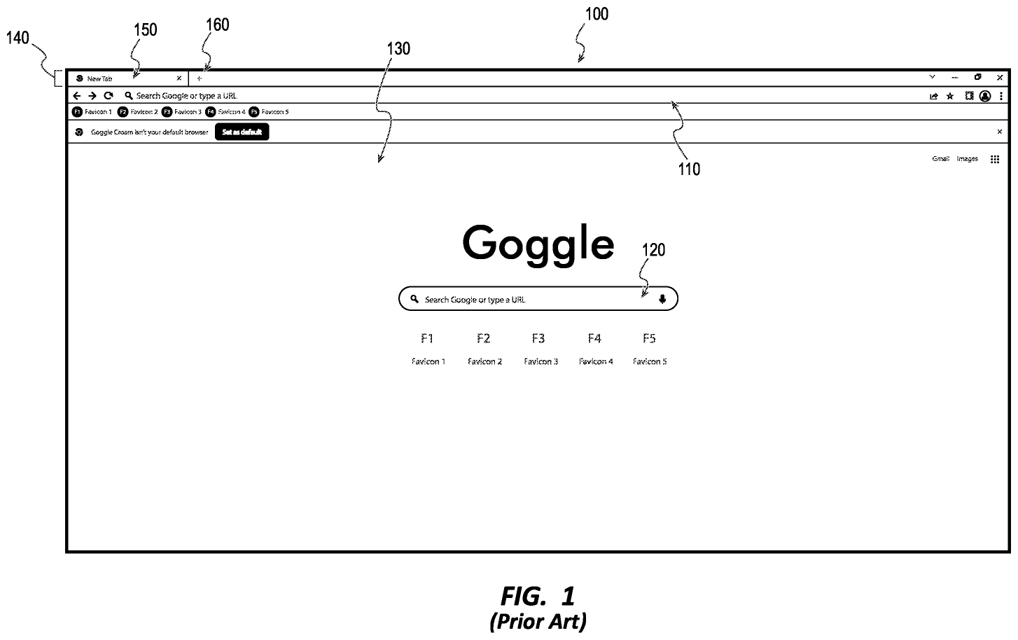

Attention will now be directed to FIGS. 1, which illustrates a conventional existing browser window 100.

In this illustration, a user can enter a search term or URL into a URL field 110 or other type of query field 120. Results of the search can be rendered as webpages (such as webpage 130). When a search is performed, the new search result content will replace the content shown in webpage 130. A tab view bar 140 contains a tab 150 that is associated with the currently displayed content and the search results that will be displayed. Once the web content is updated, the tab will also be updated to reflect the corresponding association.

A user can also create or access additional tabs in the tab view bar 140 to view different content that will be associated with and rendered with a plurality of different tabs. In some instances, in order to trigger the launch of a new tab, which may be associated with a base launch webpage, similar to what is shown in webpage 130, a user can select the “+” icon 150. In other instances, a user can trigger the creation of new tabs and corresponding tabbed content by applying a right mouse click on one of the favicon links shown in the bookmark view bar 170, or on the webpage 130, or any other link rendered in a displayed webpage, and select a menu control (not shown) to “Open in New Tab,” for example.

Unfortunately, as mentioned earlier, there is no existing technique for automatically and conveniently managing the navigation session state and context of the different tabbed content, particularly relative to different tabs that are created in similar or disparate processes. It can also be difficult to organize and navigate between different tabs with conventional techniques, particularly when there are many tabs that have been created from different searches and techniques that may not be related to each other.

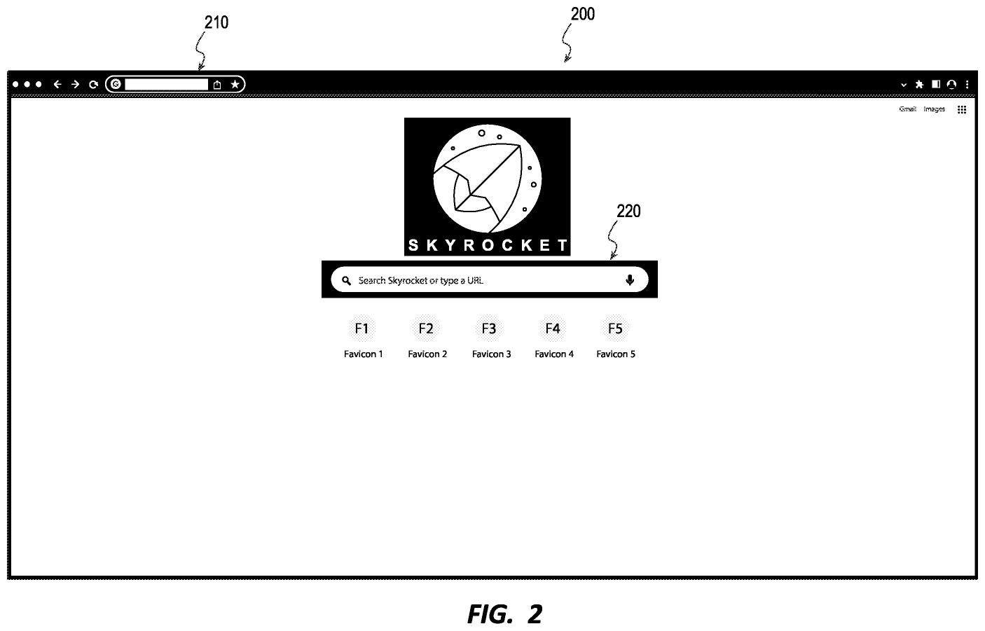

FIGS. 2-12 illustrate non-limiting examples of browser windows that are configured to utilize containers to facilitate and preserve query seminality in web browsing.

As shown, a browser window 210 is rendered with a query field (e.g., URL field 210 and/or a search term/URL field 220). When a user enters one or more search terms into the query field, the system will perform a search for related web content that is accessible through the Internet or other network databases corresponding to the entered search term(s). Notably, the search terms entered may comprises a single set of search terms for a single search or a ballistic multi-query that includes two or more sets of search terms for a plurality of respective searches.

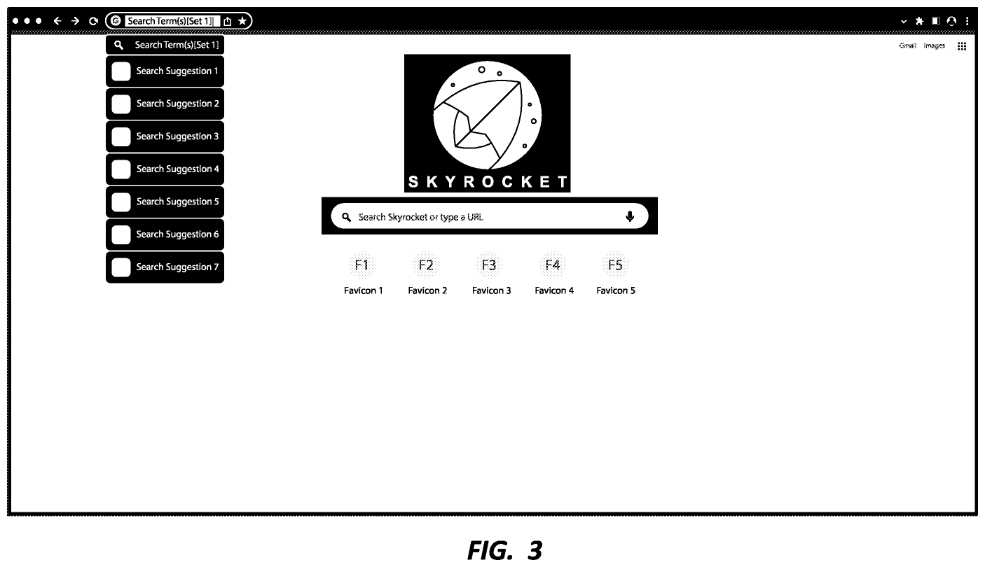

In some instances, as the user is entering the search term(s), the system will prompt the user with possible search term suggestions, as shown in FIG. 3. The user can enter their own search term(s), select a displayed suggestion, and/or select a displayed link (e.g., favicons1-favicon5 links) to trigger a search for related content comprising a single webpage or a plurality of related search result webpages from one or more different sources.

The search results may include or exclude a SERP webpage (search engine result page) corresponding to the search query and different webpages that are determined to be most relevant to the search terms for the particular user based on heuristic algorithms applied by the search engine(s) linked to the browser.

When the search results are rendered for a particular search, according to the disclosed embodiments, they are grouped into a container and the search result content and tabbed pages are cached for easy access. Each search result webpage is associated with a different tab that is automatically created by the browser. In this manner, the user does not need to individually open a separate tab for each search result. The different tabs are automatically created and rendered on the browser within a tab view bar 410.

A container icon 420 is also created and rendered on the browser window within a container view bar 430 or ribbon. The container icon 420 can have the same name as the search term(s) entered into the query field 440 to initiate the query, or a portion of the search term(s), or a derivative of the search term(s), or another name or label that is associated with (but different than) the search term(s) and that reflects a context, meaning or classification of the search term(s). For instance, if the search terms were “Ford, GM, Tesla”, the container icon 420 may be rendered with a container name/label “Cars”.

Other query status information can also be included in the label, such as timestamp information, reflecting when the search was performed or updated, search engine used, etc. Sometimes this information is only accessible when hovering over the container icon to view a popup status window with the information.

The manner in which the different tabs are arranged within the tab view bar and the manner in which the system selects which search results are included in the tabbed search results, can vary to accommodate different needs and preferences. For instance, different user preferences and profiles and different user settings can control how many search results are returned for a search and in what order they are presented. The ordering can also be based on the search engine SERP, which may itself be included in or excluded from the rendered tabbed search results of a container.

When more search results are obtained then there is room to display tabs for in the tab view bar, the unseen results can include tabs that are organized and scrolled to through the tab scroll bar control 450.

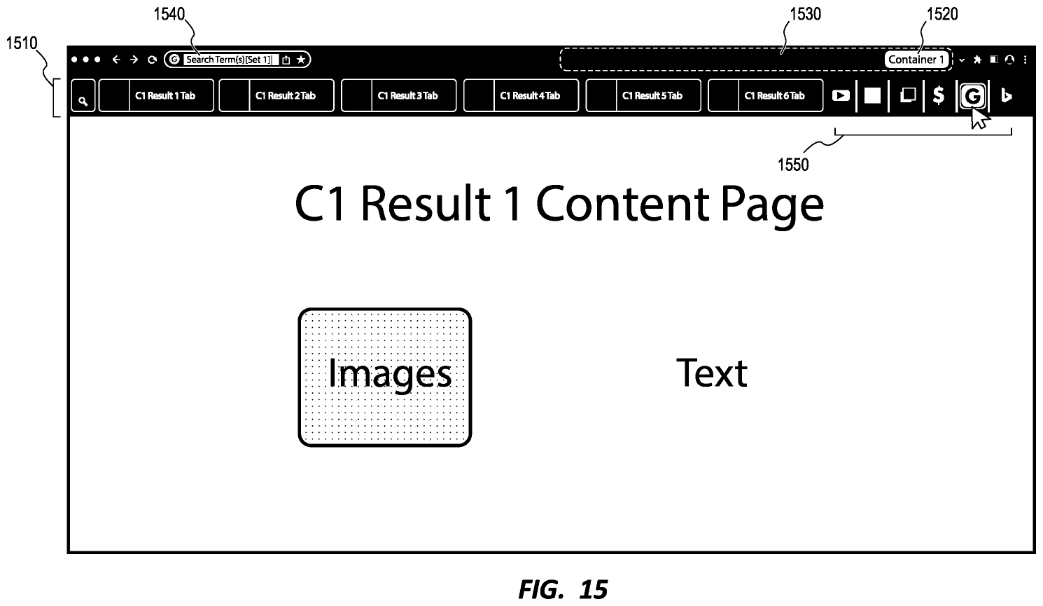

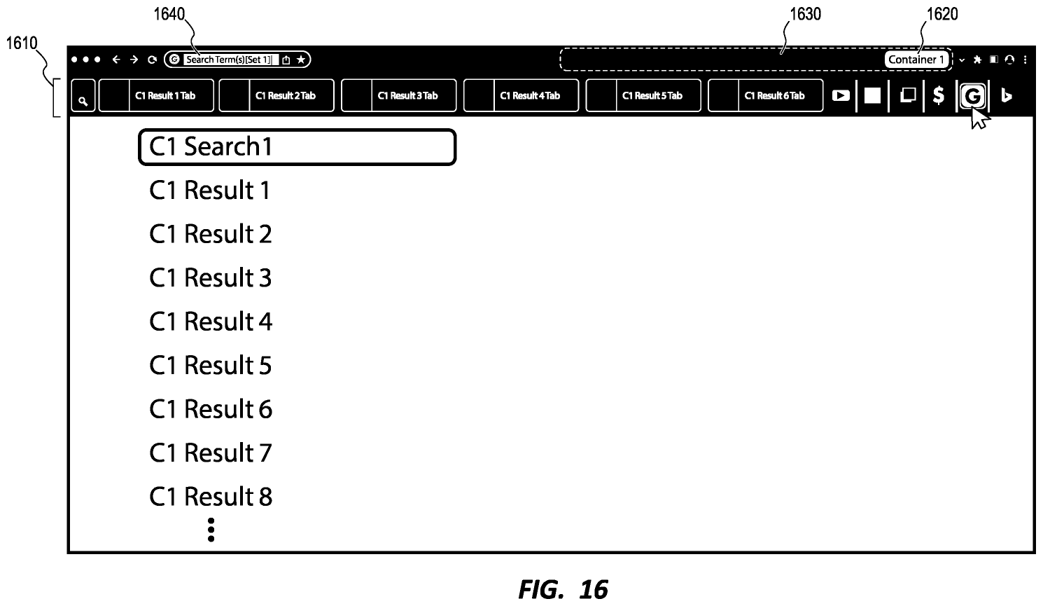

In alternative embodiments, when more search results are obtained then there is room to display tabs for in the tab view bar, the system simply limits the quantity of displayed tabs to the quantity that there is room to display without organizing any additional scrollable tabs the view bar object. In these embodiments, described in more detail below with reference to FIGS. 15-19, the additional search results for which there was not room to render tabs is simply maintained in a SERP (Search Engine Results Page) and a SERP icon is displayed instead of the tab scroll bar control 450. When a user selects the SERP icon, they are redirected to the SERP which will be displayed on the window browser (replacing previous content in the browser window), along with links to the different search results from the SERP, as described in reference to FIG. 16.

In yet additional embodiments, not shown, the system may present the tab scroll bar control 450 along with the SERP icon, to scroll to unseen tabs for search results from the SERP, as well as to access the SERP page directly, being redirected to the SERP, by selecting the SERP icon.

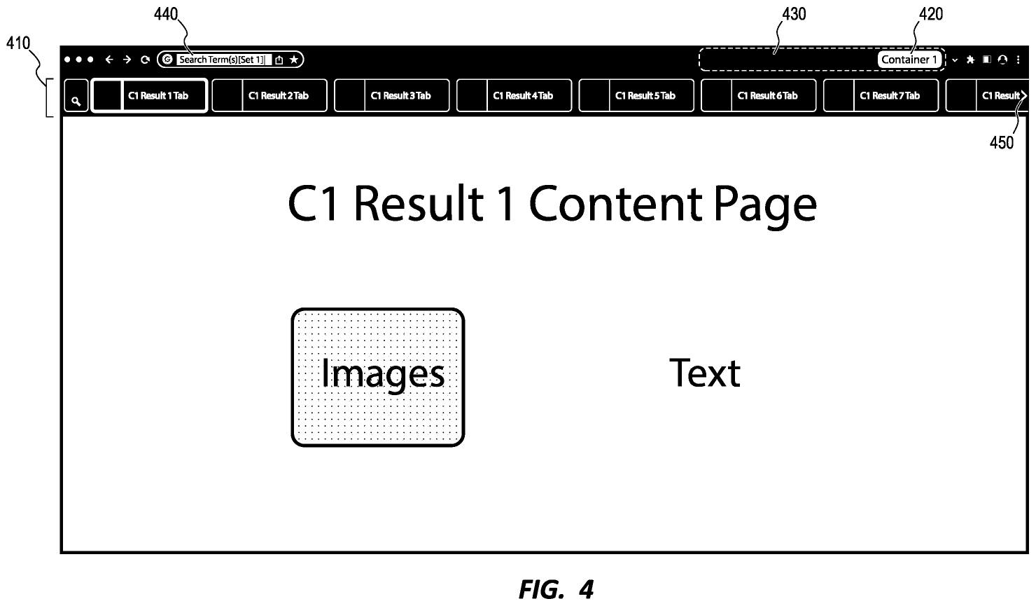

Back to FIG. 4, automatically in response to initiating a search that creates the search results for a container that has the search result tabs mentioned above, a first webpage corresponding to one of the tabs will be automatically rendered in the browser window. In FIG. 4, for example, the results corresponding to a first tab in the view bar 410 corresponding to the active container icon 420 are presently represented as C1 Result 1 Content Page, along with its own respective images and text. Notably, as stated, this webpage is rendered automatically, subsequent to initiating the search and creating the container with the tabbed search results, or alternatively, in response to a user selecting a tab (e.g., C1 Result 1 Tab) from the tab view bar 410 that is associated with that webpage.

In some instances, the first rendered webpage that is rendered after a search is performed is the SERP or, alternatively, the first search result that is identified in the SERP. When a webpage is rendered, the tab associated with that content is visually highlighted or visually distinguished from the other tabs in the view bar to show which tab the content corresponds to.

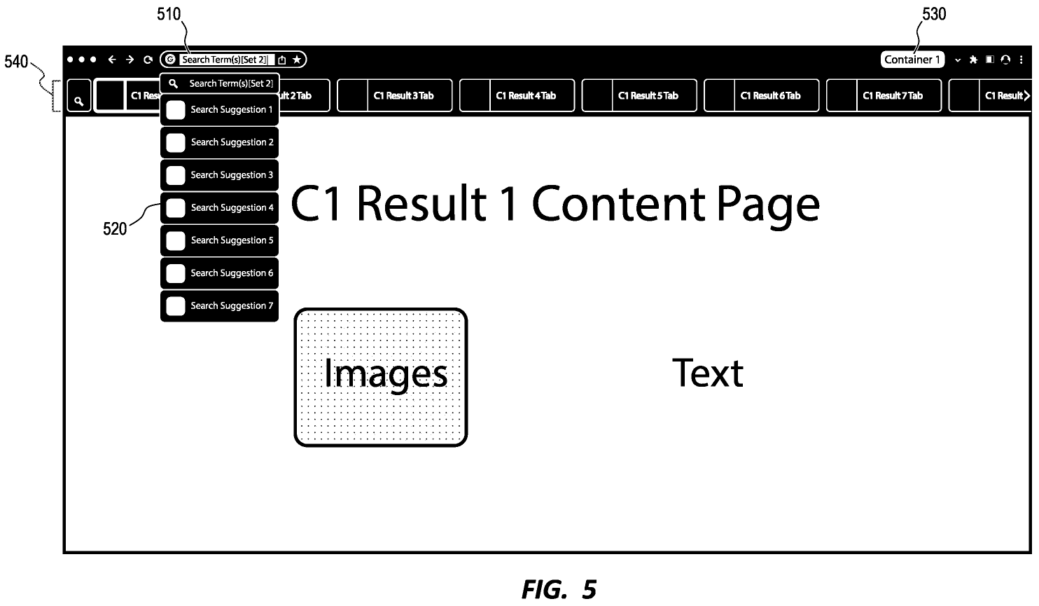

FIG. 5 illustrates an embodiment in which new search term(s) are entered into the query field 510 to trigger a new search of different content then the content that was returned in response to the first search. As before, the system can assist with suggestions for completing the set of search term(s), should a user decide to select one of the illustrated search term suggestions 520.

In alternative embodiments, the suggestions 520 are actual website links that correspond to the search terms that are being entered, while a search is dynamically being performed on the search terms as they are entered, rather than search term suggestions.

It is noted that the tabbed search results from the first search, corresponding to the first container (e.g., C1 Result 1 Tab, C1 Result 2 Tab, etc.), are still rendered along with the container icon 530 (container 1) for that first container, even while the second set of one or more search terms are being entered for the second query. In this regard, the first container is still in an active focus state (e.g., a state in which the search result content from that container is being rendered). The container icon 530 (container 1) can also be highlighted or rendered with animation or a particular type of distinguishing coloring, sizing, texturing, font, labels, symbols and/or other indicators to reflect that the referenced container is in an active focus state and that it corresponds to the currently rendered tabbed search results associated with the tabs shown in the tab view bar 540.

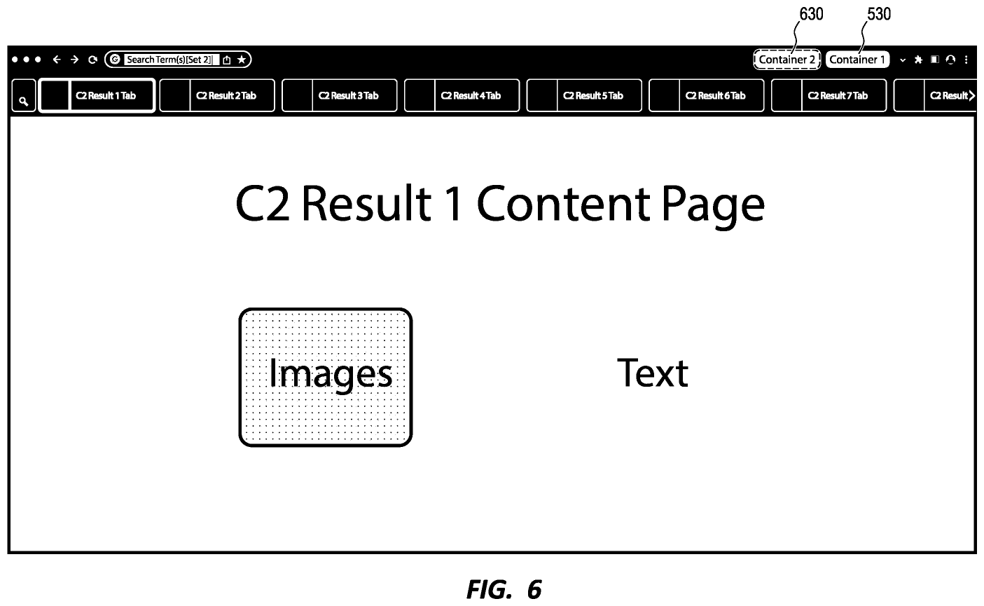

FIG. 6 illustrates an embodiment in which a search has been performed, based on the search terms entered in FIG. 5, and how this search process triggered the generation of a new container (e.g., container 2) having tabbed search results comprising webpages that are grouped within the new container and that include associated tabs (e.g., C2 Result 1 Tab, C2 Result 2 Tab, etc.) that are shown in the tab view bar, with each tab corresponding to a different search result webpage/resource.

A new container icon 630 (Container 2) is also created and highlighted with dashed lines to reflect the active focus state of this new container. Additional or different highlighting can also be used, as described earlier.

Additionally, the rendering of container icon 530 (container 1) has also been modified to indicate that the corresponding container is no longer the focus of the attention and is in an effective inactive attention state. That said, the browser can still perform functions for the container in an inactive focus state (e.g., perform background updates on the search and status of related search result content for that container), as will be described later.

In FIG. 6, since the second container is now in an active focus state, the tabs of that container are rendered (e.g., C2 Result 1 Tab, C2 Result 2 Tab, etc.), as is a first webpage corresponding to that container (E.g., C2 Result 1 Content Page). The corresponding tab (C2 Result 1 Tab) for that first/displayed webpage is also visually distinguished to reflect its association with the rendered webpage content.

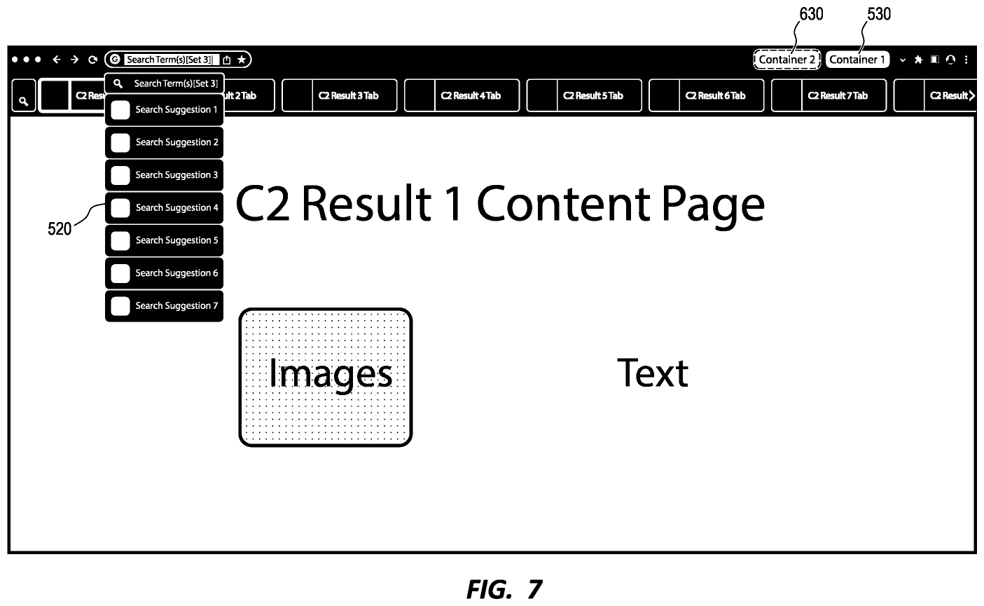

FIG. 7 illustrates another example in which, after the first and second query containers are created, a user enters new search terms (search term(s)[Set3]) into the query field to initiate a new search. At this time, prior to the search being performed for the new search terms, the second container is still maintained in the active focus state, with highlight container tab 630 (Container 2) and corresponding tabbed content being rendered with their tabs (C2 Result 1 Tab, C2 Result 2 Tab, etc.). In this state, as previously mentioned, the content from one of the search result webpages (C2 Result 1 Content Page) is displayed along with its associated highlighted tab (C2 Result 1 Tab).

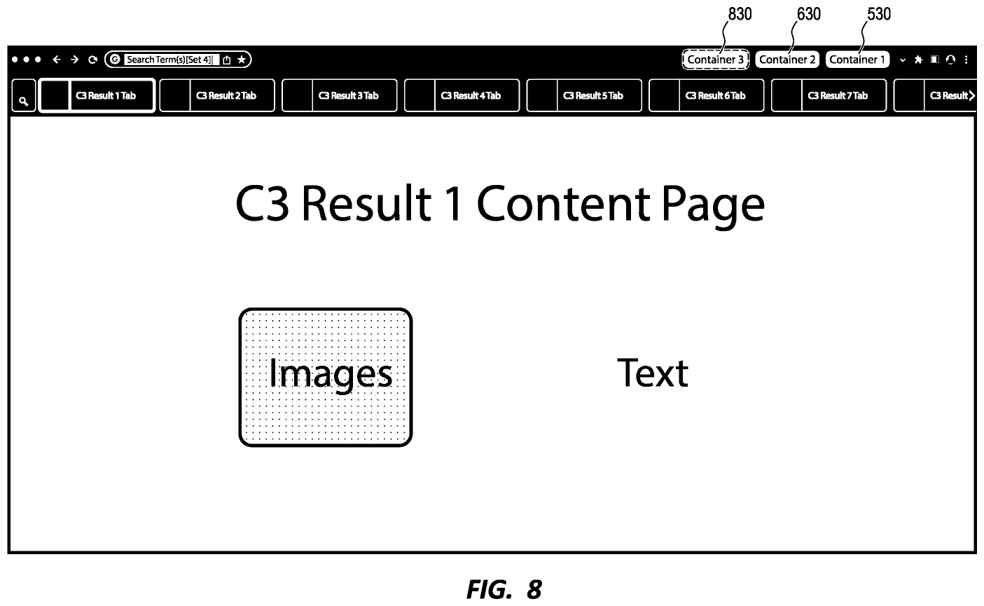

FIG. 8 illustrates yet another example in which, after the first, second and third query containers are created, based on three different searches, a user enters new search terms (search term(s)[Set4]) into the query field to initiate a new search. At this time, the third container is still in the active focus state, with highlight container tab 830 (Container 3) and corresponding tabbed content being rendered with their tabs (C3 Result 1 Tab, C3 Result 2 Tab, etc.) and with content from one of the search result webpages (C3 Result 1 Content Page) being displayed for the associated highlighted tab (C3 Result 1 Tab). The remaining containers are in an inactive focus state, as reflected by the current rendering of their container icons 630 and 530.

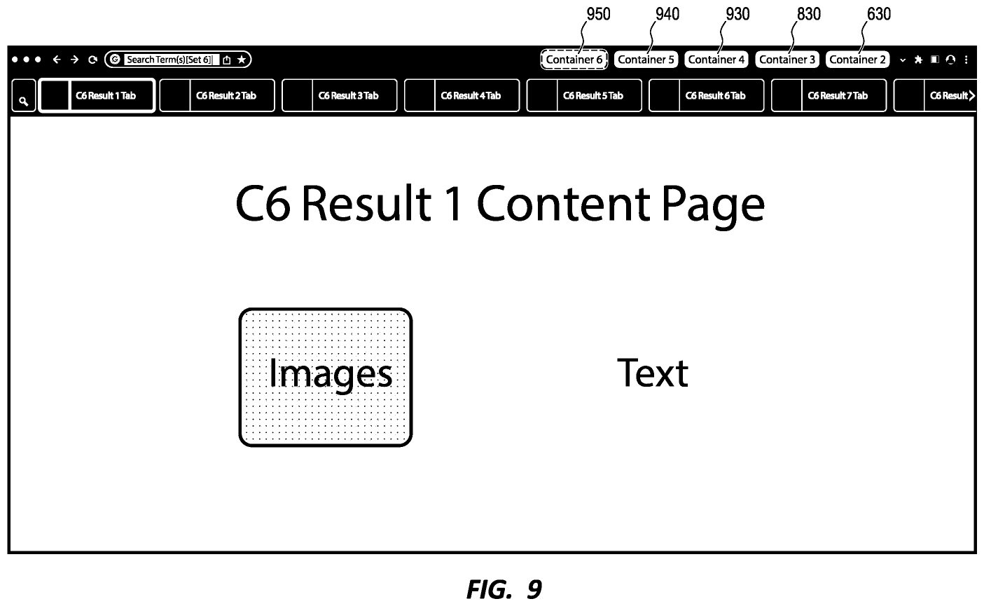

In some instances, once a predetermined quantity of containers has been opened, for which all of the corresponding container content is cached for easy access, any new container creation will bump a previous container from the listing in the container view bar. This is shown, for example, in FIG. 9.

In FIG. 9, after the first, second, third, fourth and fifth queries are opened, based on five different sequential searches, a sixth search is performed and a sixth container is created. The sixth container is shown as being currently open and in an active state (with container 6 icon 950) being rendered in a highlighted/distinguished manner relative to the other container icons (940, 930, 830 and 630), which correspond to the immediately preceding searches.

Notably, container icon 530 (Container 1) is omitted from the listing, as the creation of the new container bumped container 1 from the listing of the predetermined threshold of five containers. The predetermined quantity of containers that may be identified in a container view bar may be five, or less than five, or more than five, to accommodate different needs and preferences. Alternatively, this limit may not be a fixed quantity, but may be variably based on space provided within the browser window and based on the length of the container icon labels/names. For instance, if the browser window is very small and the container names are lengthy, then only a few containers may be able to be included.

In some instances, containers can be scrolled off of the screen and accessed through scroll controls. In other instances, as in this case, the container listing is not scrollable and any containers that are not included in the listing must be accessed through a historical container navigation log.

In some embodiments, when a container is removed from the container listing shown in the container view bar, the search results of that container are deleted from the system/browser cache, to preserve memory for the search results of other containers and processes. The system also stops active update processes that are running, in some embodiments, for containers identified in the container view bar, to preserve processing overhead.

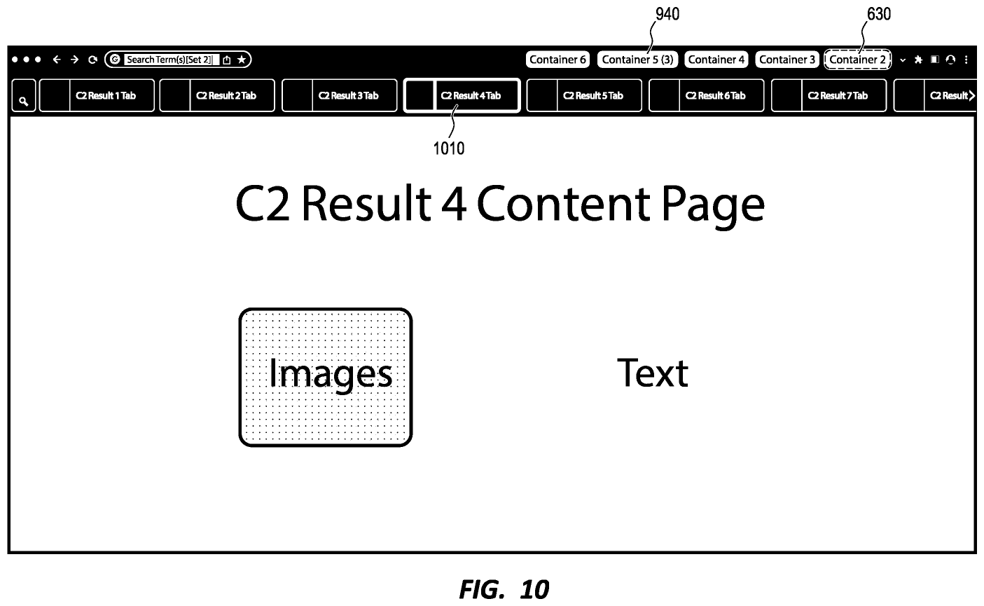

FIG. 10 illustrates how a user can navigate between the different containers to access content grouped within each of the different containers. In this embodiment, a user has navigated away from the content that was previously being displayed from a different container, by selecting container icon 630 (Container 2). Accordingly, the user is now being displayed tabbed content from container 2. However, rather that initiating the display with the first default webpage of this container, as it did the first time the system/browser showed the container content, it immediately loads/displays a search result website associated with the fourth tab 1010 (C2 Result 4 Tab). The reason for this is because this is that last webpage viewed by the user when the user previously explored the content of this container (not shown), which occurred earlier in the navigation session, prior to navigating to a different container and then returning to this container.

To facilitate the foregoing, the navigation history and browser state of each container is beneficially stored. This information can track the navigation endpoints/stops for each container and can thereby facilitate an immediate return to those stops when a user returns to the same container, as now shown.

As also shown in FIG. 9, a container tab (e.g., container tab 940) can be updated with an indicator that search results corresponding to the container have been updated. This, notably, may occur even when the container is in an inactive focus state. For instance, the system can run a background task to update the search results for the different containers. When new results are identified, relative to the previous search, the corresponding container icon can be updated to reflect the number of new search results and/or search result content webpages that have been updated. In this instance, the container icon 940 has been updated with a number “3” to reflect there are three new webpage results.

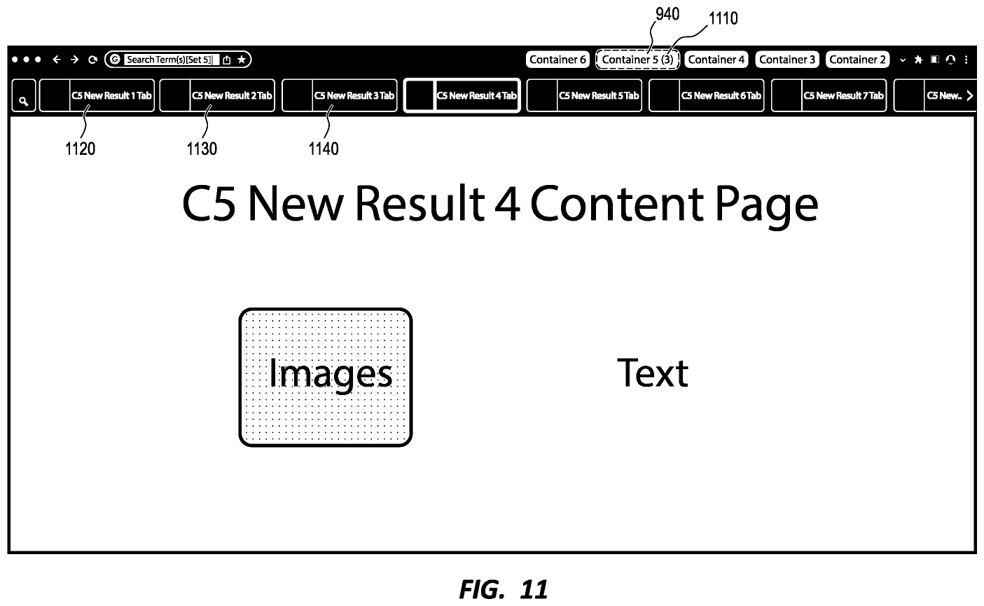

Then, when the user selects the container icon 940, the user can be directed back to the tabbed search result content of that container, as shown in FIG. 11. In this scenario, the container 5 icon 940 is highlighted to reflect the active focus status of the container and the corresponding tabbed search results are presented via associated tabs presented in the tab view bar. In this embodiment the first three tabs correspond to the new and/or updated search result content that was discovered in the background task while the user was navigating a different container's contents. These tabs (1120, 1130 and 1140) can be highlighted and/or visually distinguished to reflect they are new. Labels can additionally or alternatively be used to reflect that they are new tabs.

Currently, the browser window is reflecting the content (C5 New Result 4 Content Page) that was previously presented as C5 Result 1 Content Page when the container was last explored and prior to the addition of the three new tabbed webpages. Once the user views the new tabbed content associated with tabs 1120, 1130 and 1140 and/or when the user navigates away from this container, the container icon 940 can be updated to remove the new content indicator 1110.

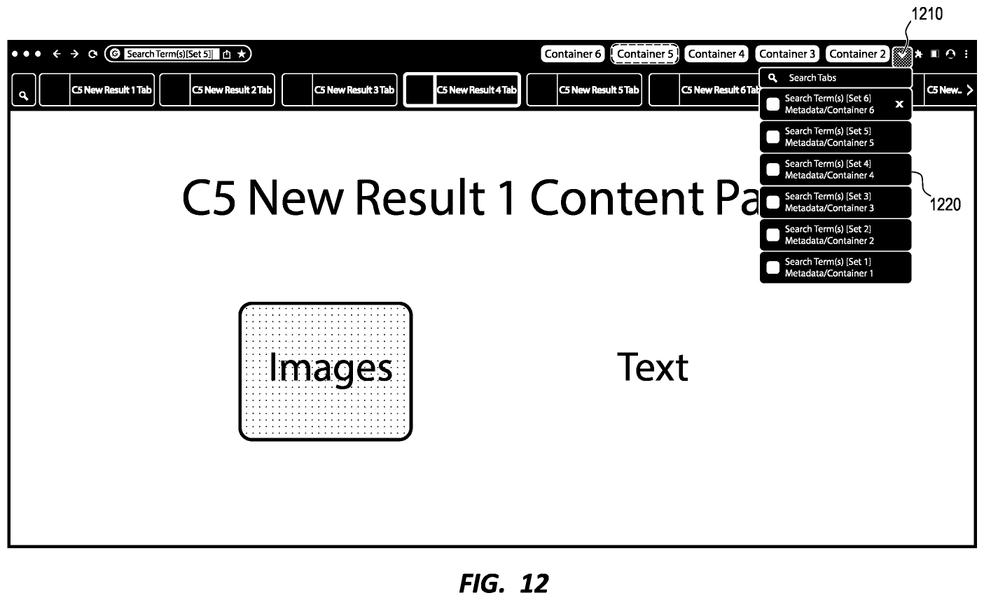

FIG. 12 illustrates an embodiment in which a user can still review and access prior navigation history in their browsing session and access search results from containers that have been dropped from the container view bar. In this embodiment, a user can select a control (e.g., control 1210) to access a navigation container log 1220 that shows the different searches that have been performed for the different containers. This listing/log may recite search terms, container names or other identifiers associated with prior searches and/or containers presented in the current browsing session and/or a previous browsing session.

When a user selects a search or container identifier from the navigation container log 1220, the system will re-instantiate the container in the browser window and reposition the corresponding container icon in the container view bar. This process may also drop another container out of the container view bar, as previously noted, if there is not room for both within a spatial or numerical limit. The re-instantiating of the container causes the system to perform the search again, for the terms that are associated with the container, and to render the container in the active focus state with the corresponding tabbed content being displayed, as previously described.

In some embodiments, when the search query of one container is determined to be contextually relevant to another search query of another container, the system will merge the tabbed results from the two or more search queries into a single tabbed grouping and the two containers will be merged with a correspondingly new merged container tab icon. In some instances, the merging occurs automatically in response to determining a threshold of relevance. In other instances, a user is notified of the relevance and given a selectable option to merge the containers or not. A user can also merge containers (e.g., with a command and/or drag drop of one container icon onto another container icon) to create an all-inclusive merged list of search results from both containers.

In yet other embodiments, a user can drag and drop container icons onto each other, to create a filtered merge of the search result contents between the two or more containers, such that the updated tabbed search results include only (mutually inclusive) results that satisfy both sets of search terms for each container.

Finally, to further facilitate the manner in which multiple queries can be performed and managed from a single browser session, while also preserving the seminality of the browsing session, the disclosed systems enable ballistic searches or searches in which multiple search queries are instantiated at a single time, to be performed in parallel or serial processing.

By way of example, a user can enter the terms “Batman.Cat.Car” into the search query field. The periods between the terms are ballistic search term separators. This means that the system should perform a separate search for the term “Batman” a separate search for the term “Cat” and a separate search for the term “Car,” either simultaneously or sequentially, with each set of search results preferentially being grouped into a separate container. The system can then render a webpage for one of the tabbed search results of one of the containers, as previously described, with either the first or last container being the selected container to have active focus status. The other container(s) will be assigned inactive focus status. Animations may also occur to show the creation of the different containers and completion of the different searches. (E.g., a container icon can be created for each term separately and slide into placement from the search query tab to the container view bar.

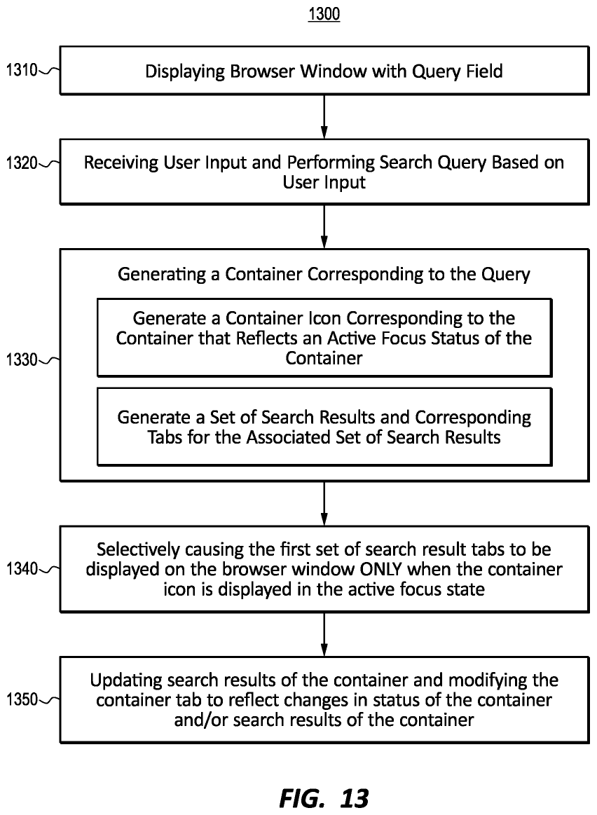

Attention is now directed to FIG. 13, which illustrates a flow diagram of acts associated with the disclosed embodiments. As shown, the first act includes the display of a browser window with a query field (act 1310). Then, the system performs a search for content comprising search results corresponding to the first query (e.g., search terms entered into the query field) (act 1320).

Then, the system, generates a container for the search query (act 1330). This may include, for example, generating and displays a first container icon at the browser window corresponding to the first query, the container icon being displayed in an active focus state prior to receiving any user input selecting and activating a different container icon in the browser window subsequent to displaying the first container icon in the active focus state. The container generation also includes generating a first set of search result tabs corresponding to the first query, each search result tab in the first set of search result tabs corresponding to a different search result resource related to the first query.

The system also selectively causes the first set of search result tabs to be displayed on the browser window when the container icon is displayed in the active focus state. Notably, when the container is not in the active focus state, its tabbed content is refrained from being displayed (act 1340).

Other acts may also be included, such as the act of updating the search results of the container and modifying the container tab to reflect changes in status of the container and/or search results of the container (act 1350). The updating may be based on background processes (e.g., updating a search based on original search terms and/or based on different sets of merged search terms from merged containers).

In some embodiments, the disclosed methods also include: receiving user input selecting and redirecting focus to a second container icon in the browser window subsequent to displaying the first container icon; and in response to the user input selecting and redirecting focus to the second container icon, (i) refraining from displaying the first of search result tabs corresponding to the first query, (ii) rendering the first container icon with an inactive focus state, (iii) generating a second set of search result tabs corresponding to the second container icon, each search result tab of the second set of search result tables corresponding to a different search result resource related to a second query, and (iv) rendering the second container icon in the active focus state.

Other embodiments include selecting and redirecting focus to the second container icon by receiving new user input comprising the second query entered at the query field or, alternatively, by receiving user input comprising selection of the second container icon at the browser window while the second container icon is rendered in the inactive focus state. In this alternative, disclosed methods further include changing a displayed state of the second container icon from the inactive focus state to the active focus state.

Some disclosed embodiments also include generating and rendering an identifier at the first container icon to reflect a change in state of a search result resource corresponding to the first query while the first set of search result tabs are not being displayed.

Other embodiments include: automatically updating the search corresponding to the first query while displaying the second container icon in the active focus state; and generating and rendering an identifier at the first container icon to reflect the creation of a new search result tab included in an updated first set of the search result tabs corresponding the first container icon, the new search result tab corresponding to a new search result resource identified in the updated search prior to displaying the updated first set of search result tabs with the new search result tab.

Other embodiments include receiving user input selecting the first container icon displayed with the identifier and responsively rendering the updated first set of search result tabs with the new search result tab, wherein the new search result tab is rendered with highlighting that distinguishes the new search result tab as a new search result tab in the updated first set of search result tabs.

Other embodiments include caching content for each search result resource corresponding to a displayed search result tab of the first container which is rendered within the browser window, as well as clearing the search result resource from the cache in response to detecting that the first container icon has been removed from the view bar. When removed, the container icon can be referenced in an overflow listing of previously navigated container content.

Some embodiments further include receiving user input selecting a particular search result tab of the first container prior to receiving user input selecting the second container icon which causes the system to refrain from displaying the search result tabs corresponding to the first container; and receiving additional new user input selecting the first container icon and responsively redisplaying the search result tabs corresponding to the first container icon, wherein the redisplaying of the search result tabs includes highlighting the particular search result tab that was previously selected and without requiring new user input to reselect the particular search result tab.

Other embodiments include the utilization and facilitation of a ballistic query. These embodiments include determining whether a search query is a ballistic query, wherein the ballistic query comprises a first query set of one or more terms separated by a ballistic separator from a second query set of one or more terms, the ballistic separator indicating that the first query set corresponds to the first search and that the second query set corresponds to a separate search to be performed subsequent to performing the first search, wherein the method also includes generating a second container icon for search result tabs corresponding to search results associated with the separate search. This ballistic query can be a period, hyphen, and/or another predetermined term separator.

Yet other embodiments include generating and rendering the first container icon when the first search is completed and generating and rendering the second container icon proximate the first container icon when the separate search is completed.

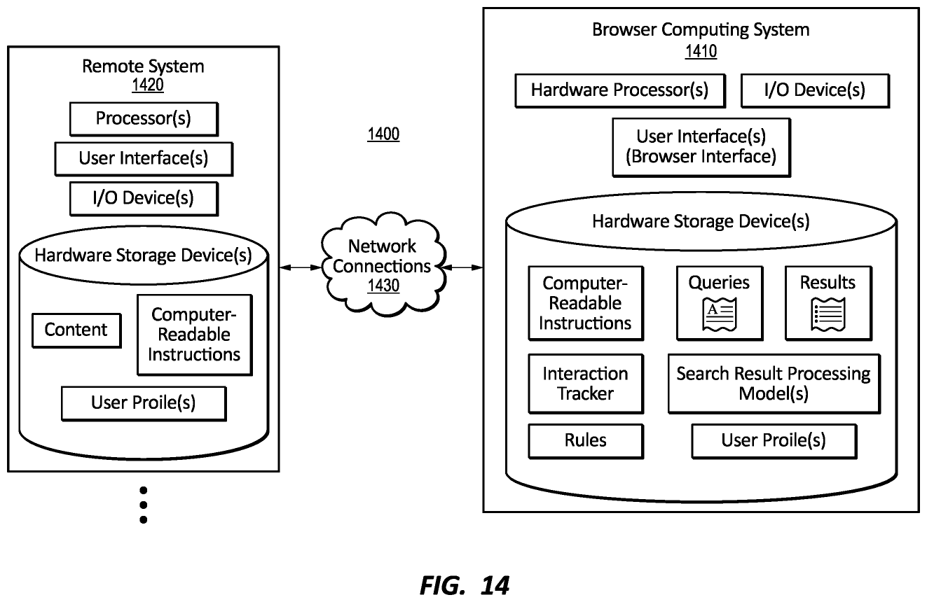

Attention will now be directed to FIG. 14, which illustrates a computing environment 1400 comprising computing systems that include and/or that may be used to implement aspects of the claimed invention. As shown, the computing environment 1400 includes a browser computing system 1410 in communication with at least one remote system 1420 through network connections 1430. The Network connections 1430 may include any combination of wired and wireless connections. Each of the browser computing system 1410 and/or the remote computing system 1420 may be stand-alone devices. They may also each comprise distributed computing systems with any of the computing components described in reference to the computing systems being distributed among two or more separate computers or computing systems, whether locally or remotely located from each other.

Each of the computing systems also includes one or more hardware processor(s), user interface(s), I/O devices, and hardware storage device(s). The hardware storage devices store computer-executable instructions that are executable by the corresponding hardware processor(s) to implement the disclosed methods and functionality described herein.

The referenced user interfaces may include browsers and other application interfaces that receive user input (e.g., search queries and selections of webpage content) that is entered at an I/O device (e.g., keyboard, mouse, touch screen, microphone, etc.) and that present/display or otherwise render information, such as webpage content and search results, to a user on a computer display screen or other I/O device (e.g., phone screen, speaker, haptic feedback device, headset display, etc.).

The browser computing system 1410 also stores rules for the browser and other user interfaces to function and to perform the referenced functionality described herein, including functionality to search for content from the remote systems to be rendered as tabbed search results that are grouped within containers.

During runtime, queries are received and stored as state information for the different containers. Likewise, search results can be stored in cache at the system, selectively, based on whether a container is referenced in a container view bar presented within the browser.

Various rules, user profiles and search result processing models can be used to perform a search and to determine which ordering of tabbed content should be searched for and selected/presented to the user through the browser in one or more containers. User interactions can also be tracked to enable navigation between the different containers and tabbed container contents.

Attention is now directed to FIGS. 15-19, which illustrate embodiments in which a predetermined quantity of tabs are generated and displayed in a view bar 1510 for different search results that are obtained from a search engine in response to a user entering a query into query field 1540. A container icon 1520 shown in container region 1530 is associated with the search results and the corresponding tabs that are rendered in the view bar. This embodiment is similar to the previous embodiments described in reference to FIGS. 4-12, for example.

In this embodiment, however, the scroll control icon 450 has been replaced with a federated icon panel 1550 that includes a plurality of icons associated with different types of federated search results related to the search query entered into query field 1540 and/or that correspond to the scope of search for a particular container selected from the one or more container icons displayed in container region 1530 (although only one is shown at the moment, “container 1”).

In this embodiment, each of the icons in the federated icon panel 1550 can be selected to display results and/or tabs corresponding to search results of the corresponding type. By way of example, one icon can correspond to video results, another can correspond to image results, another can correspond to news results, another can correspond to shopping or e-commerce results, another can correspond to SERP results from a particular search engine (e.g., Google, Bing, Yahoo, or other search engine). To help provide more clarity, some non-limiting examples will now be provided.

Currently, in FIG. 15, the webpage corresponding to the first selected and/or presented container tab (i.e., C1 Result 1 Tab) is displayed in the browser window. This webpage comprises the C1 Result 1 Content Page with images and/or text. If another tab associated with Container 1 is selected, namely, another tab in the view bar 1510, then the webpage associated with that newly selected tab will be rendered in the browser window (as previously discussed). However, in this instance, the user is selecting a search engine icon (i.e., a Google SERP icon) from the federated icon panel 1550. When this selection is made, the system will replace the content in the browser window with the SERP results from the Google search engine that was used to generate the preset quantity of container tabs contained in the view bar 1610.

For instance, as shown in FIG. 16, the C1 Result 1 Content Page has been replaced with a SERP webpage that renders a listing of search results associated with Container 1 and the search query performed as the impetus for creating Container 1. The representation of the SERP webpage in FIG. 16 is very simplified to focus on the core concept. Appreciably, the presentation and layout of the SERP page can be modified to accommodate different needs and preferences. In this example, the tabs in the view bar 1610 include tabs for the first six search results in the SERP webpage, which correspond to Container 1 (1620) that is selected in the container region 1630 of the browser and that correspond to the search query in the search query field 1640, as shown. If a user wants to seem more than one of the first six search results, they can simply select the search engine SERP icon from the federated panel tab, as described, to see the full set of search results that can each be individually selected from the rendered SERP webpage to access the corresponding webpage of a selected result.

Similarly, if a user wants to see a different scope of results for the same search query entered into a search query field 1740 and/or that correspond to the same container 1720 selected or shown in a container region 1730 of the browser, the user can simply select a different icon from the federated icon panel that corresponds to the search scope desired (E.g., video results, image results, shopping results, news results, results from a different search engine, etc.).

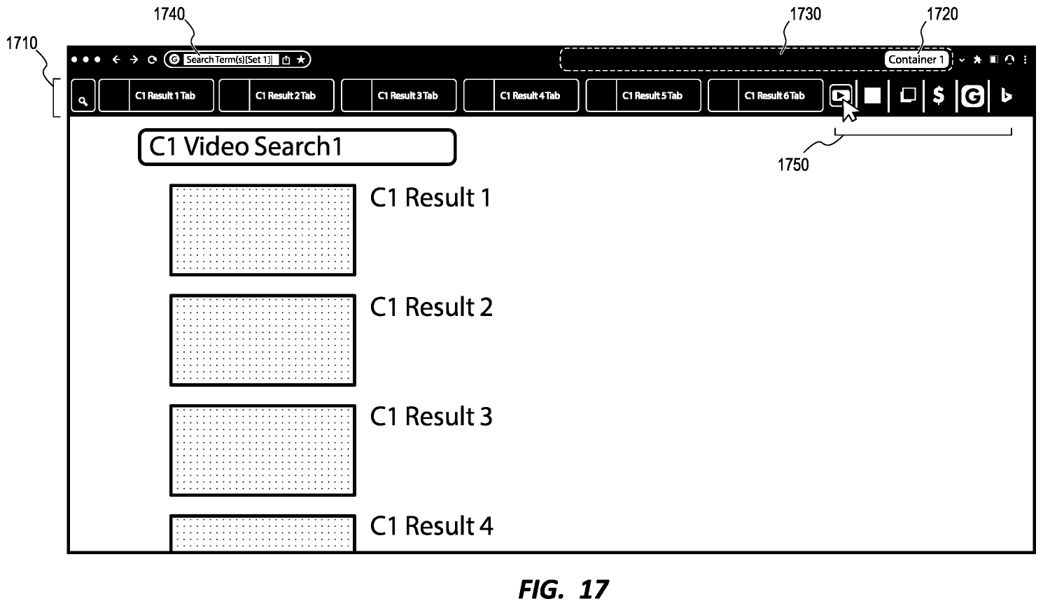

By way of example, if a user selects a video icon from the federated icon panel 1750, the system will render a listing of videos in the browser window that correspond to a filtered set of search results that are videos, as shown in FIG. 17. The tabs in the view bar 1710 can still persist showing the six tabs (or any other predetermined quantity of tabs that the system has determined to render in the view bar along with the federated icon panel) that correspond to the initial search results that are relevant to the corresponding search query and container 1 search parameters. Then, a user can access a video search result webpage from either the video search result page by scrolling and/or selecting a desired search result. Likewise, if a user wants to jump back to a particular search result from the SERP page, the user can select the SERP page and make a selection from the resulting SERP page that will be displayed from the selection and/or by selecting a tab in the view bar that corresponds to the desired search result. In some instances, a video search result will be one of the top/first search results from the SERP page and be represented by one of the tabs in the view bar, as well as within the video search result page and SERP page.

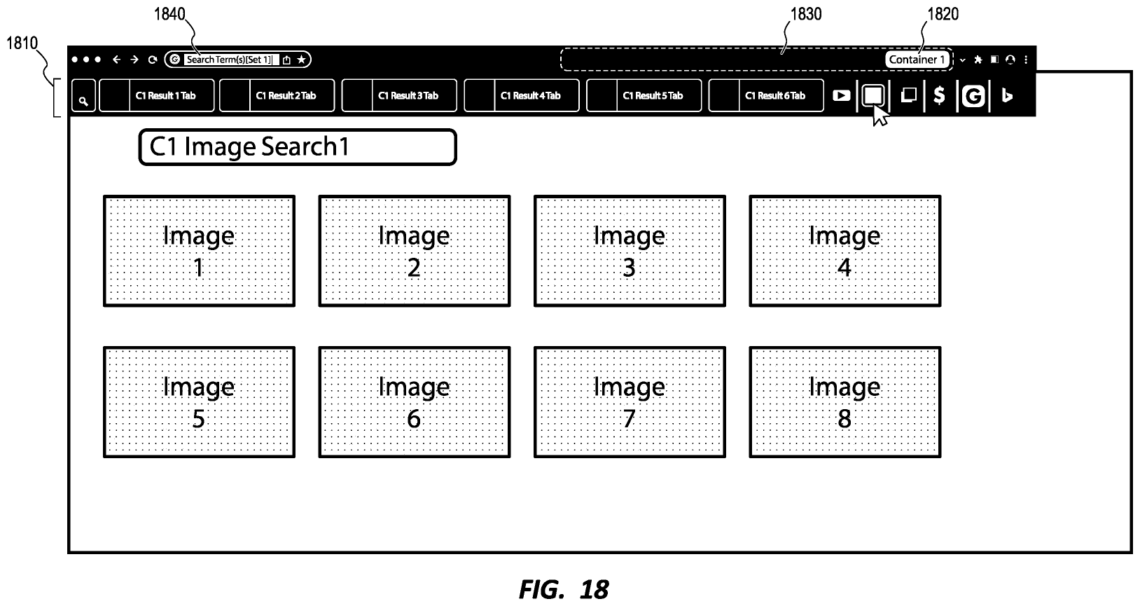

In a related example, a user can select an image icon from the federated icon panel 1750 to generate a resulting image search result page. This image search result page (shown in FIG. 18) includes images associated with terms from the search query presented in query field 1840 and/or that correspond to the container represented by the container icon 1820 shown in container region 1830 and for which a predetermined quantity of first and/or most relevant search results are represented by tabs in the view bar 1810. These image results are simply filtered search results that comprise images. If a user chooses to access a webpage containing the image, a user simply needs to select the image to cause the system to access and render the webpage corresponding to the image.

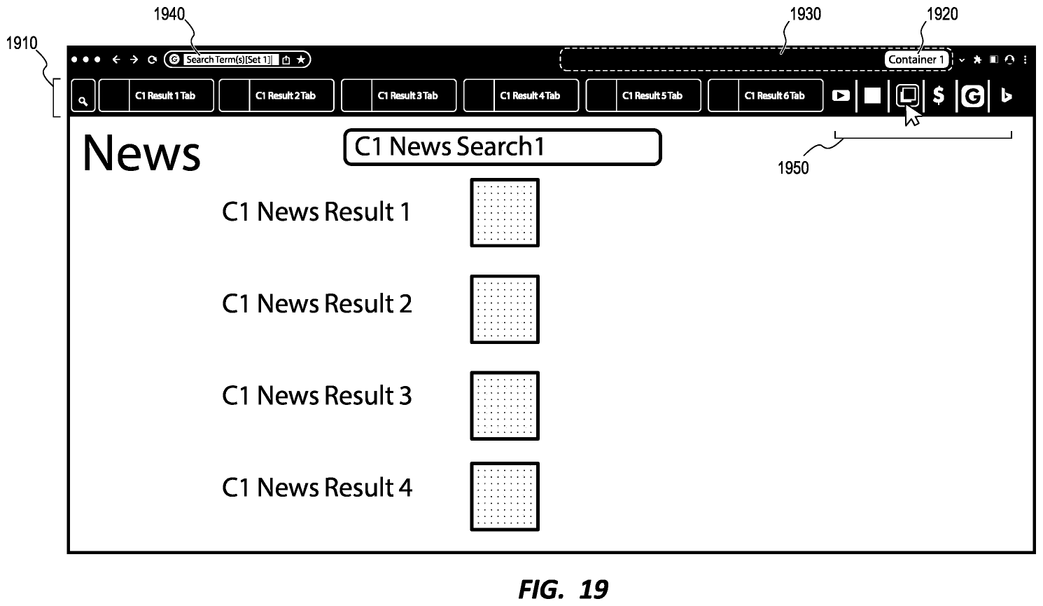

In a related, but alternative embodiment, a user can select a news icon from the federated icon panel 1950 to cause the system to render a set of filtered news results for the search query presented in query field 1940 and/or that correspond to the container represented by the container icon 1920 shown in container region 1930 and for which a predetermined quantity of first and/or most relevant search results are represented by tabs in the view bar 1910, as shown in FIG. 19. As shown, each of the news results can be rendered by the browser with a selectable text link and a corresponding image that will cause the system to render the corresponding news webpage when the text link and/or image is selected.

Although not shown, a user can also access other types of filtered/federated search results for a search query corresponding to a selected container by selecting the federated search icon from the federated icon panel. This can include, as mentioned before, accessing search results from different search engines and/or filtered search results of any particular content type. (e.g., a type based on enterprise or company specific scoping, a particular genre, age, rating, demographic, political, gender, geographic and/or other type of relevance/type.

In these embodiments, described in reference to FIGS. 15-19, the federated icon panel can include any quantity of icons associated with the referenced federated/filtered types of search results corresponding to a particular container/search query. The federated icon panel can also be presented simultaneously with a predetermined quantity of tabs (e.g., 2, 3, 4, 5, 6, 7 or another quantity of tabs) that correspond to the first or most relevant search results obtained from the SERP that is returned by a search engine in response to the initial search query/container scope.

Preferably, the predetermined quantity of tabs and the federated icon panel are presented without additional scrolling tabs for scrolling through the tabs/search results in the view bar, to conserve space. However, in some alternative embodiments, the scroll control (e.g., control 450) is presented to also allow flexibility for scrolling tabs/results from the view bar directly.

In these embodiments, a system receives user input selecting one of the federated icon panel icons to cause the system to render a different federated/filtered search result corresponding to a particular type of content that is selected from a variety of different types of content, even though all of the different types of content corresponding to the different icons in the federated icon panel correspond to a same set of search terms and/or containers that broadly define an overall scope of search to be performed.

The federated icon panel icons are presented with a predetermined set of tabs corresponding to a SERP of a particular search engine. A user can access webpage content associated with one of the tabs by selecting the corresponding tab from the view bar and/or by selecting the SERP icon from the federated icon panel to cause the system to display the SERP and then by subsequently selecting the search result that also corresponds to the relevant tab directly from the SERP webpage that is rendered. When the search result and/or tab are selected, the corresponding webpage is displayed and the corresponding tab is displayed with highlighting in the view bar.

The system also continues to display a same set of tabs in the view bar that correspond to a particular container, regardless of which federated icon panel icons are selected (even after multiple sequential selections from the federated icon panel), unless and until a new search is performed and/or a new container is selected, such as by a selection of a container tab from the container region of the browser interface.

Embodiments of the present invention may comprise or utilize a special purpose or general-purpose computer, such as referenced in FIG. 13, including computer hardware, as discussed in greater detail below. Embodiments within the scope of the present invention include, for example, physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry computer-executable instructions without storing the computer-executable instructions in a recordable-type media. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

It will be appreciated that the scope of this disclosure includes computer program products comprising one or more storage devices having stored computer-executable instructions which are executable by one or more processors of a computing system for causing the computing system to implement the methods and functionality described herein. Likewise, the disclosed embodiments include computing system(s) comprising one or more processors and one or more storage devices having stored computer-executable instructions which are executable by the one or more processors for causing the computing system(s) to implement the methods and functionality described herein.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method implemented by a computing system for facilitating browsing navigation and for managing browsing session states, the method comprising the computing system:
displaying a browser window with a query field;
receiving user input comprising a first query entered at the query field;
performing a search for content comprising search results corresponding to the first query;
generating and displaying a first container icon at the browser window corresponding to the first query, the container icon being displayed in an active focus state prior to receiving any user input selecting and activating a different container icon in the browser window subsequent to displaying the first container icon in the active focus state;
generating a first set of search result tabs corresponding to the first query, each search result tab in the first set of search result tabs corresponding to a different search result resource related to the first query; and
selectively causing the first set of search result tabs to be displayed on the browser window only when the container icon is displayed in the active focus state.

2. The method of claim 1, the method further comprising:
receiving user input selecting and redirecting focus to a second container icon in the browser window subsequent to displaying the first container icon; and
in response to the user input selecting and redirecting focus to the second container icon, (i) refraining from displaying the first of search result tabs corresponding to the first query, (ii) rendering the first container icon with an inactive focus state, (iii) generating a second set of search result tabs corresponding to the second container icon, each search result tab of the second set of search result tables corresponding to a different search result resource related to a second query, and (iv) rendering the second container icon in the active focus state.

3. The method of claim 2, wherein the selecting and redirecting focus to the second container icon includes:
receiving new user input comprising the second query entered at the query field.

4. The method of claim 2, wherein the selecting and redirecting focus to the second container icon includes:
receiving user input comprising selection of the second container icon at the browser window while the second container icon is rendered in the inactive focus state and wherein the method further includes changing a displayed state of the second container icon from the inactive focus state to the active focus state.

5. The method of claim 2, wherein the method further includes generating and rendering an identifier at the first container icon to reflect a change in state of a search result resource corresponding to the first query while the first set of search result tabs are not being displayed.

6. The method of claim 2, wherein the method further includes:
automatically updating the search corresponding to the first query while displaying the second container icon in the active focus state; and
generating and rendering an identifier at the first container icon to reflect the creation of a new search result tab included in an updated first set of the search result tabs corresponding the first container icon, the new search result tab corresponding to a new search result resource identified in the updated search prior to displaying the updated first set of search result tabs with the new search result tab.

7. The method of claim 6, wherein the method further includes receiving user input selecting the first container icon displayed with the identifier and responsively rendering the updated first set of search result tabs with the new search result tab, wherein the new search result tab is rendered with highlighting that distinguishes the new search result tab as a new search result tab in the updated first set of search result tabs.

8. The method of claim 1, wherein the method further includes caching content for each search result resource corresponding to a displayed search result tab of the first container which is rendered within the browser window.

9. The method of claim 8, wherein the method further includes clearing the search result resource from the cache in response to detecting that the first container icon has been removed from the view bar to an overflow listing of previously navigated container content.

10. The method of claim 1, wherein the method further includes:
receiving user input selecting a particular search result tab of the first container prior to receiving user input selecting the second container icon which causes the system to refrain from displaying the search result tabs corresponding to the first container; and
receiving additional new user input selecting the first container icon and responsively redisplaying the search result tabs corresponding to the first container icon, wherein the redisplaying of the search result tabs includes highlighting the particular search result tab that was previously selected and without requiring new user input to reselect the particular search result tab.

11. The method of claim 1, wherein the first query comprises a ballistic query comprising a first query set of one or more terms separated by a ballistic separator from a second query set of one or more terms, the ballistic separator indicating that the first query set corresponds to the first search and that the second query set corresponds to a separate search to be performed subsequent to performing the first search, wherein the method also includes generating a second container icon for search result tabs corresponding to search results associated with the separate search.

12. The method of claim 11, wherein the method includes generating and rendering the first container icon when the first search is completed and generating and rendering the second container icon proximate the first container icon when the separate search is completed.

13. The method of claim 1, wherein the method further includes rendering a plurality of icons within a federated icon panel, simultaneously with the first set of search result tabs that are rendered, wherein each icon in the federated icon panel is configured as a selectable object that, when selected, causes the computing system to render a federated or filtered search of the first query of a type that is different than a type of another federated or filtered search of the first query corresponding to a different icon in the federated icon panel.

14. The method of claim 13, wherein the plurality of icons within the federated icon panel includes a search engine SERP icon that, when selected, causes the computing system to render a webpage comprising a SERP corresponding to the search query and in which at least some search results included in the SERP link to webpages that are linked to by the first set of search result tabs.

15. The method of claim 13, wherein the plurality of icons within the federated icon panel includes an image icon which, when selected, causes the computing system to render images corresponding to the search query.

16. The method of claim 13, wherein the plurality of icons within the federated icon panel includes a video icon which, when selected, causes the computing system to render video links to videos corresponding to the search query.

17. The method of claim 13, wherein the plurality of icons within the federated icon panel includes a shopping icon which, when selected, causes the computing system to render links to e-commerce search results corresponding to the search query.

18. The method of claim 13, wherein the plurality of icons within the federated icon panel includes a news icon which, when selected, causes the computing system to render links to news search results corresponding to the search query.

19. The method of claim 13, wherein the plurality of icons within the federated icon panel includes a first icon corresponding to a first search engine and a second icon corresponding to a second search engine, wherein selection of the first icon causes the computing system to render search results corresponding to the search query that are obtained from the first search engine, and wherein selection of the second icon causes the computing system to render search results corresponding to the search query that are obtained from the second search engine.

20. The method of claim 13, wherein plurality of icons include an image icon corresponding to image search results, a video icon corresponding to video search results, a search engine SERP icon corresponding to general search results that include at least some of the image search results and at least some of the video search results.
